(19) United States
(12) Patent Application Publication
(10) Pub. No.: US 2025/0305825 A1
(43) Pub. Date: Oct. 2, 2025

(54) THREE-DIMENSIONAL DATA MEASURING SYSTEM AND THREE-DIMENSIONAL DATA MEASUREMENT METHOD

(71) Applicant: TOPCON CORPORATION, Tokyo (JP)

(72) Inventors: Homare MOMIYAMA, Tokyo (JP); You SASAKI, Tokyo (JP)

(73) Assignee: TOPCON CORPORATION, Tokyo (JP)

(21) Appl. No.: 19/094,564

(22) Filed: Mar. 28, 2025

(30) Foreign Application Priority Data
Mar. 29, 2024 (JP) 2024-058238

(51) Int. Cl. G01C 15/00

(52) U.S. Cl. CPC G01C 15/008

(57) ABSTRACT

The system that acquires three-dimensional data of a measurement range includes a measuring module including a housing having a grip portion, a prism, a notification unit, an electronic distance meter, and detect a distance to an irradiated point, an inertial measurement unit configured to detect posture information, and a control arithmetic unit configured to calculate position coordinates based on position coordinates of the prism and the posture information, and calculate position coordinates of the irradiated point; and a surveying instrument configured to measure a distance to and angle of the prism to acquire the position coordinates of the prism, in which the control arithmetic unit calculates an angle formed between a vector directed from the surveying instrument to the measuring module and a vector directed from the measuring module to the irradiated point, and cause the notification unit to issue a warning when the angle exceeds a threshold.

### TECHNICAL FIELD

The disclosure relates to a three-dimensional data measuring system, and more particularly, to a three-dimensional data measuring system and a three-dimensional data measurement method using a measuring module and a surveying instrument.

### BACKGROUND ART

Three-dimensional data measuring systems have been conventionally used for “current surface measurement” or “site surface survey”, which refers to the process of measuring the current condition of a surface, such as land, buildings, or structures. The current surface measurement is commonly used in construction work to assess terrain elevation and surface irregularities. Such measuring systems, including a total station having an auto-tracking function and a pole for a prism has been used in conventional current surface measurement in construction work, allows an operator to measure a measurement point by just placing the pole on the point while the total station automatically tracks the prism to measure the position coordinates of the prism. During the measurement, the operator is required to place the prism horizontally by observing a bubble-level device attached with the prism or the pole. Thus, longer working hours leads to a great burden on the operator. Besides, such a system requires the operator to know a length of the pole in advance and input the value thereof to the system.

Patent literature 1 has disclosed a three-dimensional data measuring system comprising a GNSS receiver, a tilt sensor, an azimuth sensor, and an electronic distance meter to measure three-dimensional position of an irradiated point of the electronic distance meter without using a total station and a pole.

### CITATION LIST

### Patent Literature

Patent Literature 1: Japanese Published JP 2007/248156A1

### SUMMARY

### Technical Problem

The three-dimensional data measuring system of patent literature 1 enables the measurement without a pole but does not allow the measurement in indoor environments due to poor satellite-signal reception. In addition, even in outdoor environments with strong satellite-signal reception, the timing of measurement, which affects the number of available satellites or the geometric location of satellites, may deteriorate the accuracy of the measurement.

Methods have been developed for efficiently measuring a measurement region in measurement without a pole.

Operators need a three-dimensional data measuring capable of measuring a measurement region more efficiently without using a pole for a prism or a GNSS receiver.

The disclosure has been made in view of the above circumstances, and an object thereof is to provide a three-dimensional data measuring system and a three-dimensional data measurement method capable of measuring three-dimensional data more efficiently without using a pole for a prism or a GNSS device.

### Solution to Problem

To achieve the above object, a three-dimensional data measuring system according to one aspect of the present disclosure has the following configuration.

1. According to a first aspect of the present disclosure, a three-dimensional data measuring system that acquires three-dimensional data of a measurement range and includes a measuring module including a housing having a grip portion, a prism, attached to the housing, configured to retroreflect incident light, a notification unit configured to issue a warning, an electronic distance meter, accommodated in the housing, configured to transmit distance-measuring light to the measurement range, receive reflected distance-measuring light of the distance-measuring light reflected from an irradiated point, and detect a distance to the irradiated point, an inertial measurement unit configured to detect posture information, a communication unit configured to receive position coordinates of the prism, and a control arithmetic unit configured to calculate position coordinates of an own position on the basis of the position coordinates of the prism and the posture information, and calculate position coordinates of the irradiated point on the basis of the position coordinates of the own position, a distance to the irradiated point, and the posture information, and a surveying instrument configured to measure a distance to and angle of the prism to acquire the position coordinates of the prism, and transmit the position coordinates to the communication unit, in which the control arithmetic unit is configured to calculate an angle formed between a vector directed from the surveying instrument to the measuring module and a vector directed from the measuring module to the irradiated point, and cause the notification unit to issue a warning when the angle exceeds a threshold.

2. According to a second aspect of the first aspect, the housing further includes a display unit, and the control arithmetic unit displays, on the display unit, a guidance sign for guiding an operator holding the measuring module to move in a direction of decreasing the angle when the angle exceeds the threshold.

According to another aspect of the present disclosure, there is provided a three-dimensional data measurement method using a three-dimensional data measuring system that acquires three-dimensional data of a measurement range and includes a measuring module including a housing having a grip portion, a prism, attached to the housing, configured to retroreflect incident light, a notification unit configured to issue a warning, an electronic distance meter, accommodated in the housing, configured to transmit distance-measuring light to the measurement range, receive reflected distance-measuring light of the distance-measuring light reflected from an irradiated point, and detecta distance to the irradiated point, an inertial measurement unit configured to detect posture information, a communication unit configured to receive position coordinates of the prism, and a control arithmetic unit configured to calculate position coordinates of an own position on the basis of the position coordinates of the prism and the posture information, and calculate position coordinates of the irradiated point on the basis of the position coordinates of the own position, a distance to the irradiated point, and the posture information, and a surveying instrument configured to measure a distance to and angle of the prism to acquire the position coordinates of the prism, and transmit the position coordinates to the communication unit, the method including calculating, by the control arithmetic unit, an angle formed between a vector directed from the surveying instrument to the measuring module and a vector directed from the measuring module to the irradiated point, and issuing, by the notification unit, a warning when the angle exceeds a threshold.

### BRIEF DESCRIPTION OF DRAWINGS

Various aspects and embodiments of the application will be described with reference to the following figures. Items appearing in multiple figures are indicated by the same or a similar reference number in all the figures in which they appear.

FIG. 1 illustrates an outline of a three-dimensional data measuring system according to an embodiment of the present disclosure.

FIG. 2 illustrates a configuration block diagram of a measuring module and a surveying instrument configuring the same system.

FIGS. 3A and 3B illustrate settings of a measurement range in measurement region data used in the same system.

FIG. 4 illustrates an explanatory diagram as an example of a measurement site using the same system.

FIG. 5 illustrates a measurement state of an operator gripping a measuring module. FIG. 5 also illustrates a state in which an operator stops and measures a plurality of locations as a top view.

FIG. 6 illustrates a measurement state of an operator gripping a measuring module. FIG. 6 illustrates a state in which the operator measures a plurality of locations while walking in the measurement range.

FIG. 7 illustrates a schematic diagram of FIG. 6.

FIG. 8 illustrates an explanatory diagram for describing an avoidance direction. FIG. 8 corresponds to FIG. 6.

FIG. 9 illustrates an explanatory y diagram for describing an avoidance direction. FIG. 9 corresponds to FIG. 7.

FIG. 10 illustrates a flowchart of a pre-process of a three-dimensional data measurement method using the same system.

FIG. 11 illustrates a flowchart of a main process of the three-dimensional data measurement method using the same system.

FIGS. 12A and 12B illustrate examples of display screens during measurement.

FIGS. 13A and 13B illustrate examples of display screens during measurement.

### ADVANTAGES OF INVENTION

According to the above aspect, it is possible to provide a three-dimensional data measuring system and a three-dimensional data measurement method capable of measuring three-dimensional data more efficiently without using a pole for a prism or a GNSS device.

### DESCRIPTION OF EMBODIMENTS

Hereinafter, preferred embodiments of the present disclosure will be described with reference to the drawings, but the present disclosure is not limited thereto. In each embodiment, the same constituents are denoted by the same reference signs, and redundant description will be omitted as appropriate.

### I Embodiment

### 1. Overall Configuration

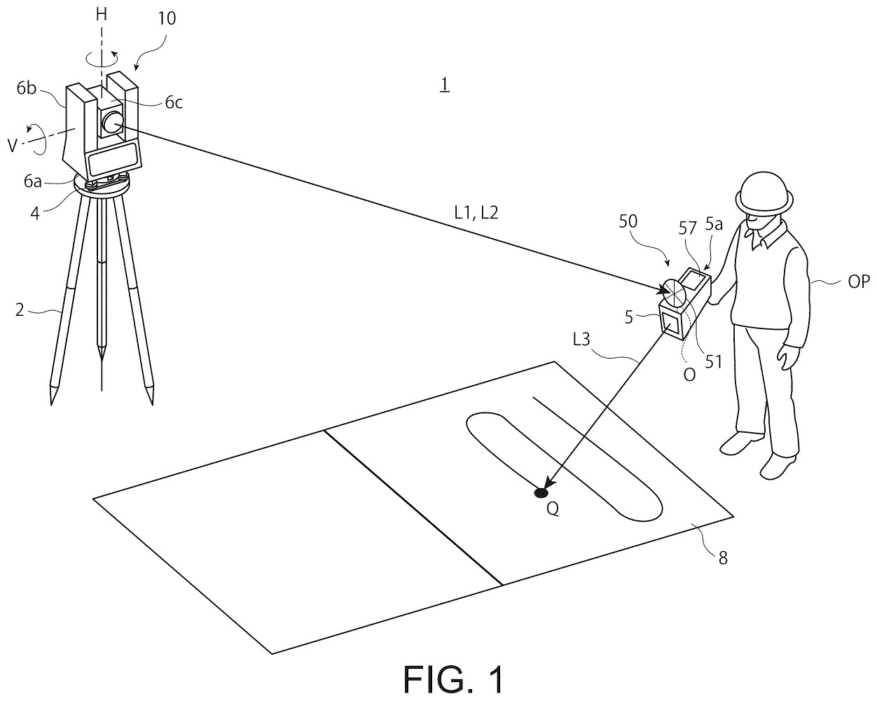

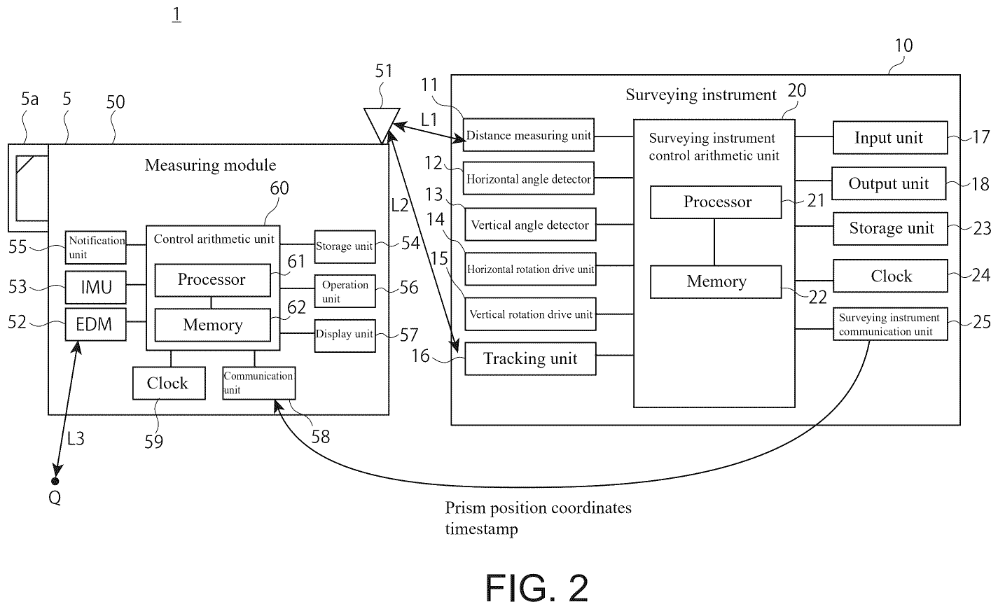

FIG. 1 illustrates a schematic configuration of a three-dimensional data measuring system 1 (hereinafter, simply referred to as system 1). The system 1 is preferably configurated for current surface measurement at a construction site. FIG. 2 illustrates a configuration block diagram of the system 1. The system 1 generally includes a surveying instrument 10 and a measuring module 50.

In the illustrated example, the surveying instrument 10 is a motor-drive total station with an auto-tracking function. The surveying instrument 10, installed at a known point, is used with the coordinates and a direction angle that are already known. Note that, in this detailed description, the expression “installing a surveying instrument at a known point” represents not only installing a surveying instrument at the known point but also installing at an arbitrary location by using a backward intersection or other methods.

As illustrated in FIG. 1, the surveying instrument 10 includes, a base portion 6a, a bracket portion 6b configured to rotate horizontally about an H axis with respect to the base portion 6a, and a telescope 6c configured to rotate vertically about a V axis at the center of the bracket portion 6b. The base portion 6a is mounted on a leveling stand 4, which is attached to a tripod 2.

The measuring module 50 includes a substantially rectangular parallelepiped housing 5 in the hand-held size. The housing 5 is provided with a prism 51, which will be described later, fixed to the front side of an upper surface. The housing 5 also has a display unit 57, which will be described later, on the rear side of the upper surface. This configuration allows an operator OP to irradiate L3 at a measurement object while watching the display unit 57. The housing 5 has a grip portion 5a, and the operator OP grips the grip portion 5a to measure an object. The measuring module 50 is a so-called handheld module. The distance-measuring light L3 is emitted from a front surface of the housing 5. Providing a switch for measurement in the grip portion 5a in a trigger mechanism is preferable because the switch allows an operator to intuitively recognize a direction of the measurement, resulting in easier measurement.

### 2. Surveying Instrument 10

As illustrated in FIG. 2, the surveying instrument 10 includes a distance-measuring unit 11, a horizontal angle detector 12, a vertical angle detector 13, a horizontal rotation drive unit 14, a vertical rotation drive unit 15, a tracking unit 16, an input unit 17, an output unit 18, a surveying-instrument control arithmetic unit 20, a storage unit 23, a clock 24, and a surveying-instrument communication unit 25.

The distance-measuring unit 11 comprises a light transmitting unit, which includes a light emitting element such as a laser diode, that emits laser light L1 (e.g., infrared laser light) as distance-measuring light. The distance-measuring unit 11 also comprises a distance measuring optical system and a light receiving unit, which include a light receiving element such as an avalanche photodiode. The light emitting element, the distance measuring optical system, and the light receiving unit are not illustrated in FIG. 2. The distance measuring unit 11, housed in the telescope 6c, has an optical axis of the distance-measuring light that coincides with a collimation optical axis of the telescope 6c. The distance-measuring unit 11 emits distance-measuring light, such as infrared laser light, to the prism 51 (described later) via the distance-measuring optical system and receives reflected light with the light receiving unit to measures a distance to the center of the prism 51 based on the phase difference or the time difference between the distance-measuring light and the internal reference light.

The horizontal angle detector 12 and the vertical angle detector h implemented using absolute encoders or incremental encoders. The horizontal angle detector 12 detects a horizontal angle of the base portion 6a, that is, a horizontal angle of the collimation axis of the telescope 6c. The vertical angle detector 13 detects a vertical angle of the collimation axis of the telescope 6c.

The horizontal rotation drive unit 14 and the vertical rotation drive unit 15 are each implemented using motors. The surveying-instrument control arithmetic unit 20 controls the horizontal rotation drive unit 14 and the vertical rotation drive unit 15. The horizontal rotation drive unit 14 drives a rotation shaft, provided on the base portion 6a, to horizontally rotate the bracket portion 6b. The vertical rotation drive unit 15 drives a rotation shaft, which supports the telescope 6c rotatably with respect to the bracket portion 6b, to vertically rotate the telescope 6c. Both of the drive units cooperatively rotate the telescope 6c in the horizontal and vertical direction.

The tracking unit 16 includes a tracking light transmitting unit, which includes a light emitting element such as a laser diode; a tracking optical system; and a tracking light receiving unit, which includes an imaging element such as a charge-coupled device (CCD) or a complementary metal-oxide-semiconductor (CMOS). The light transmitting unit, the tracking optical system, and the tracking light receiving unit are not illustrated in FIG. 2. The tracking unit 16 emits infrared laser light as tracking light L2, which has a wavelength different from that of the laser light L1. The tracking unit 16 captures landscape images in a direction of the collimation axis when the tracking light Ls is on and when is off. The tracking unit 16 provides the both images to the surveying-instrument control arithmetic unit 20. The surveying-instrument control arithmetic unit 20 determines the center position of an image of the prism 51, which serves as the surveying target, by using the difference between the two images and calculating the position of the prism 51. Based on the determined position of the prism 51, the surveying-instrument control arithmetic unit 20 instructs the horizontal rotation drive unit 14 and the vertical rotation drive unit 15. This allows the telescope 6c to always point toward the prism 51.

The input unit 17 is an input device, which comprises an input mechanism, such as buttons and keys, to as commands or receive inputs from an n operator, such configuration settings for measurement tasks and output them to the surveying-instrument control arithmetic unit 20. The output unit 18 is a device that serves as a display for an operator such as a liquid crystal display. The output unit 18 displays screens, such as a measurement condition setting screen and a measurement result check screen, under the control of the surveying-instrument control arithmetic unit 20. The input unit 17 and the output unit 18 may be integrally configured into a touch panel display.

The storage unit 23 is implemented using computer-readable storage media, such as hard disc drives (HDDs) or flash memory. The storage unit 23 stores programs for the surveying instrument 10 to execute various functions such as a surveying function and an auto-tracking function. The storage unit 23 also stores various types of data, such as measurement data, acquired by the surveying instrument 10.

The clock 24 is a devise that keeps time and may be implemented using a system clock or a hardware clock. The clock 24 assigns timestamps to a piece of transmission data to synchronize a measurement timing with the measuring module 50.

The surveying-instrument communication unit 25 is a communication interface that facilitates information exchange between the surveying instrument 10 and the measuring module 50. Examples of communication means include Wi-Fi, Bluetooth (a registered trademark), and infrared communication. The communication means is not limited thereto and may be implemented using other methods compliant to known wired and wireless communication standards. The surveying instrument 10 assigns timestamps to measurement result data from the prism measurement, which include the position information of the prism. The surveying instrument 10 transmits the measurement result data to the measuring module 50 via the surveying-instrument communication unit 25.

The surveying-instrument control arithmetic unit 20 is a control arithmetic unit that comprises at least a surveying-instrument processor 21 such as a central processing unit (CPU) and at least a surveying-instrument memory 22 such as a static random-access memory (SRAM) or a dynamic random-access memory (DRAM). When the surveying-instrument processor 21 carries out functions of the surveying instrument 10 in a software manner, the surveying-instrument control arithmetic unit 20 reads programs for implementing the functions into the surveying-instrument memory 22 and executes the programs to carry out the function.

In addition, at least a part of the surveying-instrument processor 21 may be configured by hardware such as a complex programmable logic device (CPLD) or a field programmable gate array (FPGA).

The surveying-instrument control arithmetic unit 20 controls the tracking unit 16, the horizontal rotation drive unit 14, and the vertical rotation drive unit 15 to automatically track the prism 51. The surveying-instrument control arithmetic unit 20 controls the distance-measuring unit 11, the horizontal angle detector 12, and the vertical angle detector 13 to measure the distance and angle of the prism 51 at a predetermined timing. Based on the results of the distance and angle measurement of the prism 51, the surveying-instrument control arithmetic unit 20 calculates the center position coordinates of the prism 51, assigns timestamps to the results, and transmits the center position coordinates to the measuring module 50 via the surveying-instrument communication unit 25.

### 3. Configuration of Measuring Module 50

The measuring module 50 comprises the prism 51, an electronic distance meter (EDM) 52, an inertial measurement unit (IMU) 53, a storage unit 54, a notification unit 55, an operation unit 56, a display unit 57, a communication unit 58, a clock 59, and a control arithmetic unit 60. In addition, a speaker for outputting sound may be provided.

The prism 51 is, for example, a so-called omnidirectional prism, configured by radially combining a plurality of triangular pyramidal prisms to retroreflect light incident from all directions) (360°. The prism 51 is not limited thereto, and may be any prism used for surveying.

The electronic distance meter 52 includes a light transmitting unit, a distance-measuring optical system, and a light receiving unit, which are not illustrated in FIG. 2. The light transmitting unit, which includes a light emitting element such as a laser diode, emits visible laser light as the distance-measuring light L3. The light receiving unit includes a light receiving element, such as an avalanche photodiode. The electronic distance meter 52 emits the distance-measuring light L3 from the light transmitting unit toward the measurement target and receives a reflected light from the measurement target. The distance to the point irradiated by the distance-measuring light L3 is determined based on a phase difference or the time difference between the distance-measuring light L3 and internal reference light. The electronic distance meter 52 emits the distance-measuring light L3 constantly or at a predetermined timing when the measurement starts.

The inertial measurement unit 53 includes a three-axis gyroscope and a three-axis accelerometer. The inertial measurement unit 53 detects the posture information of the measuring module 50 by measuring the angular velocities and accelerations in three axis directions (roll, pitch, and yaw) of the measuring module 50. The inertial measurement unit 53 is placed at the instrument center O (FIG. 1) of the measuring module 50.

The positional relationship is predetermined among the center of the prism 51, the origin for distance calculation of the electronic distance meter 52, and the instrument center. The electronic distance meter 52 is configured so that its optical axis passes through the instrument center O. This structure enables the determination of the position coordinates of the measuring module 50 based on the position coordinates of the center of the prism 51 and the posture information of the measuring module 50.

The storage unit 54 is implemented using computer-readable storage media such as hard disk drives (HDDs) or flash memory. The storage unit 54 stores programs that execute functions of the measuring module 50, which will be described later. The storage unit 54 also stores three-dimensional information data, acquired by the measuring module 50.

The notification unit 55 issues warnings, for example, by means of light, speech, sound, or vibration to alert operators. The notification unit 55 includes a light source that blinks to indicate a state, an audio speaker for playing audio, a buzzer for generating a beep sound, and a vibrator for tactile signaling. The display unit 57 may also serve as the notification unit 55 by displaying notification information on a display screen or blinking the display screen. The warning from the notification unit 55 causes the operator OP to pay attention and take an avoidance action.

The operation unit 56 is an input device that comprises an input mechanism, such as buttons and keys, to receive inputs from the operator, such as commands or configuration settings. The operation unit 56 transmits such inputs to the measuring module 50. The display unit 57 is implemented with a display such as a liquid crystal display or an organic electroluminescence (EL) display. In the illustrated example, the operation unit 56 and the display unit 57 are integrated as a touch panel display. Furthermore, the operation unit 56 may include an audio input device such as a microphone in addition to buttons and keys. The measurement screen 70 displays various information, such as a measurement path, a position of its own, and the position of the irradiated point, which are superimposed on measurement region data.

The communication unit 58 is a communication interface that facilities information exchange between the surveying instrument 10 and the measuring module 50. Although examples of communication means include Wi-Fi, Bluetooth (a registered trademark), and infrared communication, any communication mean compatible with the surveying-instrument communication unit 25 should be used. The communication unit 58 receives position coordinates of the prism 51 from the surveying instrument 10.

The clock 59 may is a device that keeps time and may be implemented with a system clock or a hardware clock. The clock 59 is synchronized with the clock of the surveying instrument 10. The clock 59 is used for synchronizing a measurement timing with the surveying instrument 10.

The control arithmetic unit 60 includes at least one processor 61, such as a CPU, and at least one memory 62, such as an SRAM or a DRAM. The processor 61 carries out a function of the surveying instrument 10 in a software manner. The control arithmetic unit 60 reads programs for implementing functions of the measuring module 50 into the memory 62 and executes the programs to carry out the functions. At least a part of the processor 61 may be configured with hardware such as a CPLD or an FPGA.

The control arithmetic unit 60 enables remote control of the surveying instrument 10 and transmits an instruction for measurement and auto-tracking to the surveying instrument 10 via the communication unit 58. The control arithmetic unit 60 acquires a distance to an irradiated point Q measured by the electronic distance meter 52 and the posture information of the measuring module 50 measured by the inertial measurement unit 53 at a timing synchronized with the surveying instrument 10. The control arithmetic unit 60 calculates the own position coordinates of the measuring module 50, based on the position coordinates of the prism 51 received from the surveying instrument 10, the posture information of the measuring module 50, and the known positional relationship between the prism 51 and the instrument center O of the measuring module 50. In addition, the control arithmetic unit calculates the position coordinates of the irradiated point Q irradiated by the distance-measuring light L3 based on the calculated coordinates of the own position, the posture information of the measuring module 50, and the measured distance value from the electronic distance meter 52.

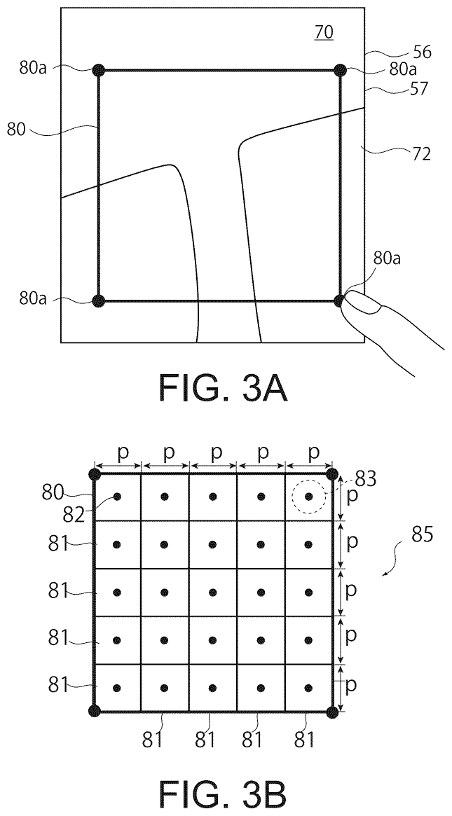

The control arithmetic unit 60 reads measurement region data 72, sets a measurement range 80 into partitioned areas. FIG. 3A illustrates how to set the measurement range 80, shown on the display unit 57. The measurement region data 72 is map data in the illustrated example. The measurement range 80 represents an area where three-dimensional data measurement has been conducted within the measurement region data 72. As illustrated in FIG. 3A, an operator taps points on the display unit 57, which is a touch panel display, to input points as vertexes 80a, and selects a rectangular shape to set the measurement range 80. Alternatively, the operator may use a rectangular selection tool and swipe diagonally to draw a rectangle on the display, which sets the measurement range 80. Although the measurement range 80 is set as a square in the illustrated example, the range is not limited thereto. The measurement range 80 may be set as any shape including a rectangular shape and a polygonal shape. In addition, the measurement range 80 may be set by tracing lines around the desired area using a fingertip.

As illustrated in FIG. 3B, the control arithmetic unit 60 partitions the measurement range 80 into mesh-like partition with predetermined pitch p in the measurement range 80. In addition, each mesh 81 should be identical in shape in principle; however, at the peripheral edge of the measurement range 80, it may have different shapes depending on the shape of the measurement range 80 because the measurement range may not be evenly partitioned. The pitch p is preferably 10 to 50 cm for the purpose of current surface measurement in construction work. Although not limited to this range, the pitch p may be appropriately determined depending on the size of the measurement range 80 and the required accuracy of the output. The control arithmetic unit 60 displays a measured mesh and an unmeasured mesh on the display unit 57 in a distinguishable manner for each partition of each mesh.

In addition, the control arithmetic unit 60 determines whether the irradiated point Q falls within a predefined distance range, which corresponds to a measurement-scheduled-point range 83 centered on a measurement scheduled point 82. When determining that irradiated point Q is within the measurement-schedule-point range 83, the control arithmetic unit 60 initiates measurement and acquires the measurement values as the measurement result. Further, the control arithmetic unit 60 displays the measured area and an unmeasured area in the display unit 57 in a distinguishable manner for each of the partitioned meshes 81. Further, the control arithmetic unit 60 displays the measured areas in various colors, in which each color represents a range of the measurement values to indicate their scale.

### 4. Avoidance of Tracking Interruption Due to Obstacle

Further, the control arithmetic unit 60 calculates a layout of an obstacle, the surveying instrument 10, and the measuring module 50, detects a possibility that the measuring module 50 is hidden behind the obstacle with respect to the surveying instrument 10, and causes the notification unit 55 to issue a warning to call attention to the operator OP.

### (Case 1; Obstacle is an Object)

The obstacle is a material that interferes with measurements, for example, a pillar or a wall surface. When the measuring module 50 (specifically, the prism 51) enters the shadow of the obstacle, the surveying instrument 10 fails to track the measuring module 50.

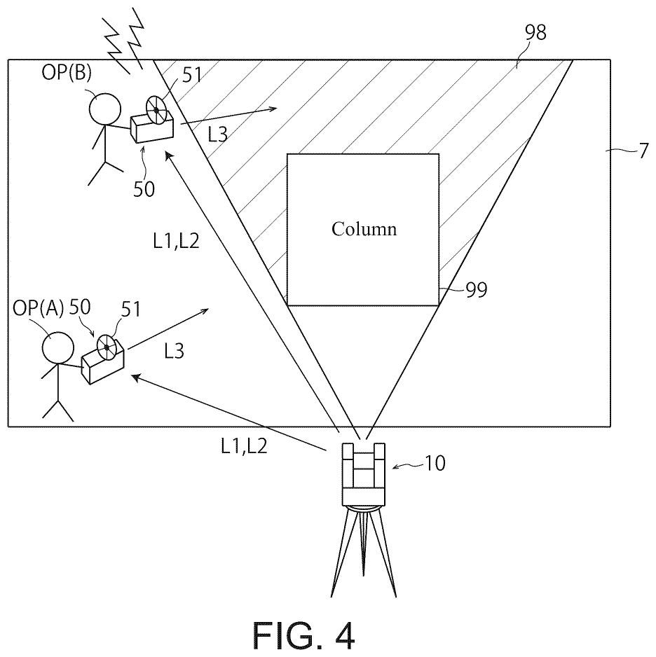

FIG. 4 is a schematic view of a surveying site where the operator OP measures 10 floor surface of a measurement region 7 provided with a rectangular column (obstacle 99) at the center of a room by using the measuring module 50.

The surveying instrument 10 is disposed at a position facing one surface of the obstacle 99. When the operator OP measures the floor surface of the measurement region 7 by using the measuring module 50, due to hindrance of the obstacle 99, a region (which is a hatched region and will be hereinafter referred to as prohibited region 98) is out of the range of tracking of the surveying instrument 10. When the measuring module 50 enters the prohibited region 98, the tracking light L2 is blocked by the obstacle 99, the surveying instrument 10 fails to track the measuring module 50 and perform continuous measurement. Furthermore, once the tracking deviates, even if the measuring module 50 leaves the prohibited region 98, it takes a considerable time for the surveying instrument 10 to re-lock the tracking target prism 51.

Thus, when an installation position of the surveying instrument 10 and the position of the obstacle 99 are confirmed from the measurement region data 72, the control arithmetic unit 60 calculates the prohibited region 98 that the surveying instrument 10 fails to measure. During the measurement, the operator OP who grips the measuring module 50 moves and when the operator OP approaches a position where a distance to the unmeasurable prohibited region 98 is within a threshold, the notification unit 55 warns the operator OP with, for example, sound, vibration, or speech.

This reduces a possibility of deviation in tracking of the surveying instrument 10. The unmeasurable prohibited region 98 may be displayed on the display screen of the display unit 57 together with the measurement region data 72 to call attention to the operator OP approaching the unmeasurable prohibited region 98.

In addition, even when no data of the obstacle 99 in the measurement region data 72 and the obstacle 99 is disposed at the surveying site, the surveying instrument 10 can ascertain that the obstacle 99 is present from measurement using the measuring module 50.

As an example, at the surveying site in FIG. 4, when the presence of the pillar, which is the obstacle 99, was not grasped in advanced, the wall surface of the obstacle 99 is measured by irradiating a side surface of the pillar with the distance-measuring light of the measuring module 50. The operator measures the floor surface, and when the irradiated point Q is measured at a height much more than a threshold, the irradiated point Q is ascertained as a part of the configuration surface of the obstacle where the floor surface is unmeasurable. As a result, the control arithmetic unit 60 can ascertain the obstacle 99 that is not in the prior data. Similarly to the obstacle 99 ascertained in advance, the unmeasurable prohibited region 98 is calculated also for the obstacle 99 ascertained at the site. The notification unit 55 is caused to issue a warning when the operator OP approaches the unmeasurable prohibited region 98 by a distance equal to or less than the threshed.

### (Case 2; Obstacle is the Operator)

Obstacles at the time of measurement also include the operator OP who holds the measuring module 50. During the measurement, the operator OP who grips the measuring module 50 moves around and may stand between the measuring module 50 and the surveying instrument 10 due to the movement and hide the measuring module 50 with his/her body, which may cause tracking of the surveying instrument 10 to deviate.

As described above, the control arithmetic unit 60 calculates coordinates of the irradiated point Q based on the distance and angle to the prism 51 measured by the surveying instrument 10, the posture information of the measuring module 50, and the measured distance to the irradiated point Q with the distance-measuring light L3. The position coordinates of the surveying instrument 10, the measuring module 50, and the irradiated point Q are ascertained. Since the operator OP grips the measuring module 50 and irradiates the irradiated point Q with the distance-measuring light L3 from the measuring module 50, the operator OP is present on an extension line of a vector directed from the irradiated point Q to the measuring module 50. Thus, a position of the operator OP can be roughly ascertained from coordinates of the surveying instrument 10, the measuring module 50, and irradiated point Q.

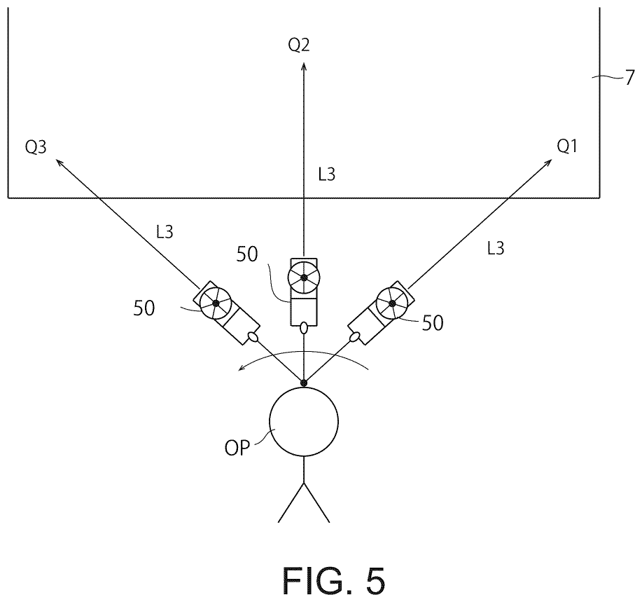

FIG. 5 illustrates a state in which the operator OP stops and measures irradiated points in a plurality of directions. The operator OP can measure a plurality of irradiated points in a plurality of directions without moving around by rotating the body or the arm gripping the measuring module 50. Since the distance-measuring light L3 is linearly emitted from the measuring module 50, the operator OP using the measuring module 50 is present on an extension line of a vector connecting the irradiated point Q and the measuring module 50.

The operator OP grips the measuring module 50 and emits the distance-measuring light L3. When the operator OP irradiates the plurality of irradiated points Q1 to Q3 with the distance-measuring light L3, the operator OP is present on the extension line between any of the irradiated points Q1 to Q3 and the measuring module 50. A position of the operator OP on the extension line of the distance-measuring light L3 is a position of a base of a hand or a shoulder of the operator OP, who is moving around while gripping the measuring module 50. The position of the operator OP may be a schematic position of the operator OP.

The control arithmetic unit 60 calculates a schematic disposition of the operator OP from respective position coordinates of the surveying instrument 10, the measuring module 50, and the irradiated points. When the measuring module 50 seen from the surveying instrument 10 may be hidden by the operator OP, the control arithmetic unit 60 causes the notification unit 55 to issue a warning and displays a guidance sign 97 on the display unit 57 to guide the operator OP. Thus, it is prevented that the auto-tracking of the surveying instrument 10 deviates and the measuring module 50 is lost. The position coordinates of the surveying instrument 10 indicate the coordinates of the instrument center of the surveying instrument 10. The position coordinates of the measuring module 50 indicate the coordinates of instrument center O. The positional relationship between the center of the prism 51, the origin for the distance calculation of the electronic distance meter 52, and the instrument center O is known in advance, and the position coordinates of the instrument center O is calculated as the position coordinates of the measuring module 50.

When the surveying instrument 10, the operator OP, and the measuring module 50 are linearly arranged in this order, it is notified that the operator OP hides the measuring module 50 from the surveying instrument 10 and the auto-tracking deviates. Specifically, when an angle θ formed between a vector (hereinafter, referred to as first vector V1) directed from the surveying instrument 10 to the measuring module 50 and a vector (referred to as second vector V2) directed from the measuring module 50 to the irradiated point Q is equal to or more than a threshold, the notification unit 55 provides a notification of a warning. Further, a guidance sign for guiding the operator OP to an avoidance direction is displayed on the display unit 57.

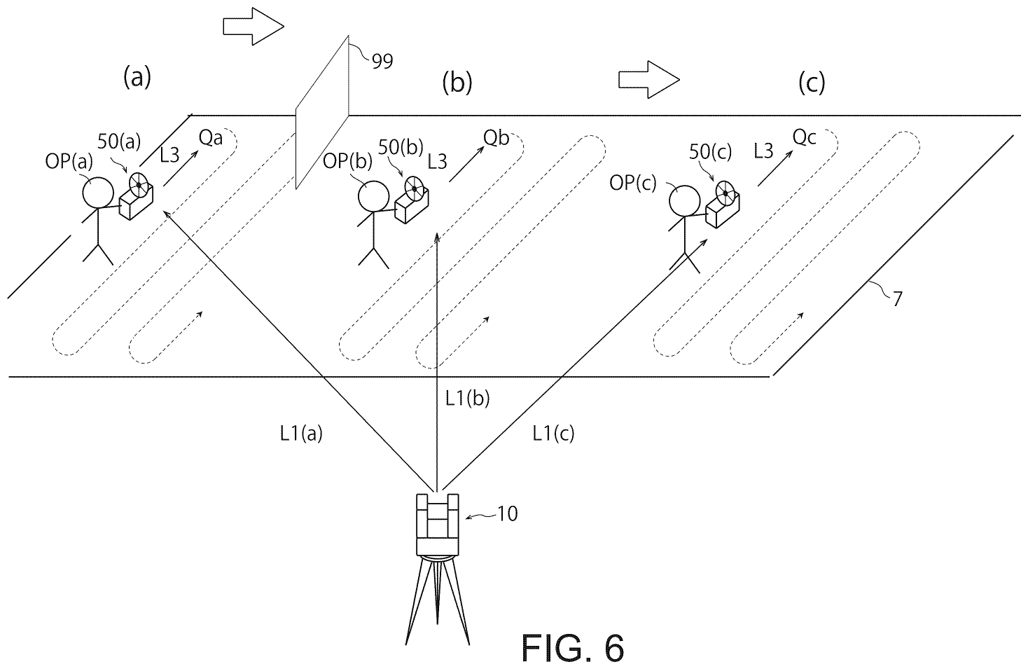

The above details will be described with reference to FIGS. 6 to 9. FIG. 6 is a schematic view of the operator OP using the measuring module 50 while moving in the measurement region 7 from a position (a) to a position (c) in a direction of a white arrow. The operator OP grips the measuring module 50 with one hand and irradiates the irradiated point Q with the distance-measuring light L3 to measure. FIG. 6 illustrates a case where the operator OP measures the farthest irradiated point at each position. In other words, the angle θ, which will be described later, becomes the largest. For avoidance of doubt, the operator OP comprehensively measures a floor surface height of the measurement region 7 by moving in the white arrow direction and swinging the measuring module 50 in a width direction (see a dotted arrow in FIG. 6). A distance between the surveying instrument 10 and the operator OP decreases from the position (a) toward the position (b), becomes the smallest at the position (b), and increases toward the position (c).

As illustrated in FIG. 6, when the operator OP measures with the measuring module 50 at the position (a), the surveying instrument 10 captures the prism 51 with the tracking unit 16 and can track the prism 51. However, when the operator OP moves from the position (a) to the position (b) and further moves to the position (c), the measuring module 50 is hidden behind the operator OP with respect to the surveying instrument 10. Thus, the auto-tracking of the surveying instrument 10 deviates at the position (c).

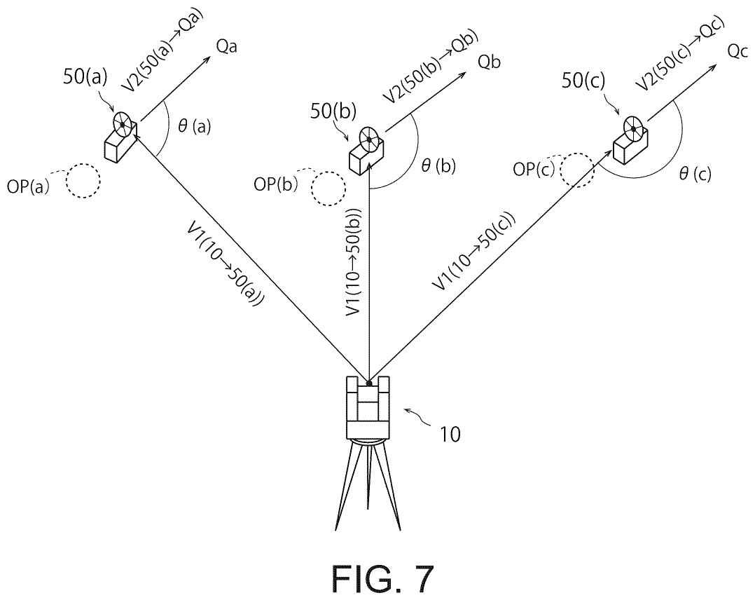

FIG. 7 is a schematic diagram illustrating FIG. 6. FIG. 7 illustrates a schematic position of the operator OP with a dotted circle. As described above, since the distance-measuring light L3 is linearly emitted from the measuring module 50, the operator OP, who performs surveying, is present on the extension line of the second vector connecting the irradiated point Q and the measuring module 50. When the operator OP enters between the surveying instrument 10 and the measuring module 50, in other words, when the surveying instrument 10, the operator OP, and the measuring module 50 are linearly arranged in this order, the measuring module 50 is hidden behind the operator OP, and the tracking deviates.

The control arithmetic unit 60 calculates the first vector V1 from the surveying instrument 10 toward the measuring module 50 and the second vector V2 from the measuring module 50 toward the irradiated point Q. The control arithmetic unit 60 determines that the surveying instrument 10, the operator OP, and the measuring module 50 are arranged on the same plane in this order when the angle θ formed between the first vector V1 and the second vector V2 is 180°.

As illustrated in FIG. 7, an angle θ(a) formed between the first vector V1 (10→50(a)) directed from the surveying instrument 10 to the measuring module 50(a) at the position (a) and the second vector V2 (50(a) →Qa) directed from the measuring module 50 to the irradiated point Qa is substantially a right angle. The operator OP is present on an extension line from the irradiated point Qa to the measuring module 50. The operator OP(a) at the position (a) does not hinder the measurement.

An angle θ(b) formed between the first vector V1 (10→50(b)) directed from the surveying instrument 10 to the measuring module 50(b) at the position (b) and the second vector V2 (50(b) →Qb) directed from the measuring module 50 to the irradiated point Qb is larger than the angle θ(a). The operator OP(b) at the position (b) is closer to the surveying instrument 10 than the operator OP(a) at the position (a).

An angle θ(c) formed between the first vector V1 (10→50(c)) directed from the surveying instrument 10 to the measuring module 50(c) at the position (c) and the second vector V2 (50(c) →Qc) directed from the measuring module 50 to the irradiated point Qc is 180°, and the operator OP(c) is present between the surveying instrument 10 and the measuring module 50 (c). In this case, the measuring module 50 is hidden by the operator OP(c) from the surveying instrument 10, and thus the surveying instrument 10 fails to track the measuring module 50.

As described above, when the angle θ=0, the angle θ being formed between the first vector V1 and the second vector V2, the surveying instrument 10 and the measuring module 50 are linearly arranged in planar view. When the angle θ exceeds 90°, the operator OP and the measuring module 50 becomes approximated to a plane seen from the surveying instrument 10. When the angle θ=180°, the irradiated point Q overlaps the measuring module 50, and the surveying instrument 10, the operator OP and the measuring module 50 are arranged on the same plane.

The control arithmetic unit 60 calculates the angle θ. When the angle θ is equal to or more than a threshold, the control arithmetic unit 60 causes the notification unit 55 to issue a warning such as sound, vibration, or speech to call attention to the operator OP. The operator OP can ascertain the state due to the warning from the notification unit 55, and can move to keep the tracking.

As illustrated in FIG. 6, the operator OP moves forward while swinging the measuring module 50 in the right-left direction of the measurement region 7. It should be noted that the angle θ changes depending on the way the operator OP swings his/her hand gripping the measuring module 50 even if the operator stands at the same position. FIG. 6 illustrates that an irradiated point is the farthest irradiated point from the surveying instrument 10 and the angle θ is the largest at each position. During the time of using the measuring module 50 by the operator OP, the angle θ has been changing, and the control arithmetic unit 60 calculates the angle θ in real time and determines whether the angle θ exceeds the threshold every time.

When the angle θ exceeds the threshold, the control arithmetic unit 60 warns the operator OP, and displays a specific avoidance direction or avoidance rotation direction to reduce the angle θ on the display unit 57 to guide the operator OP.

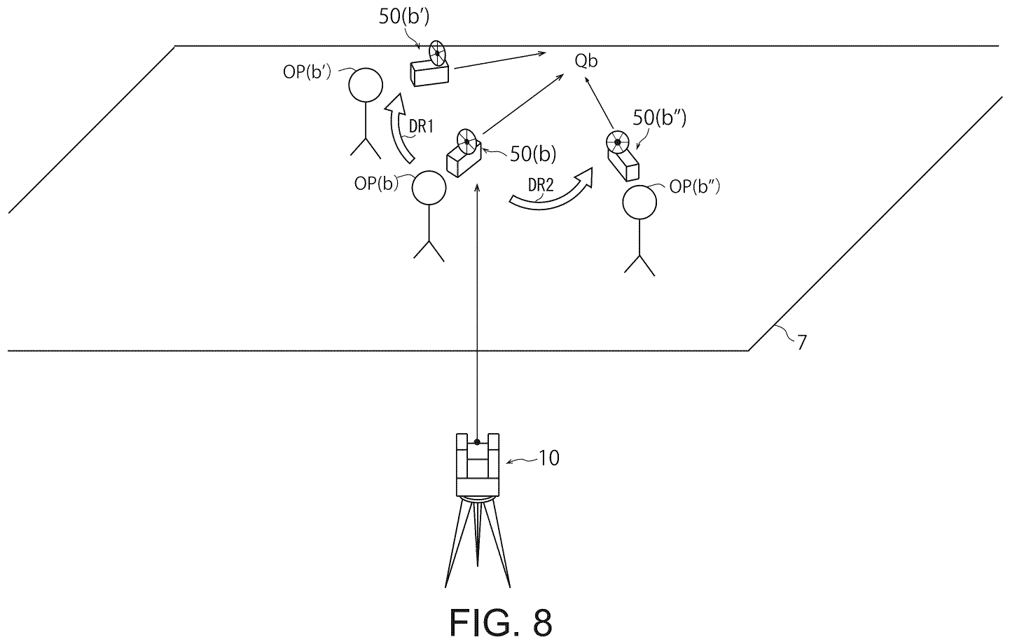

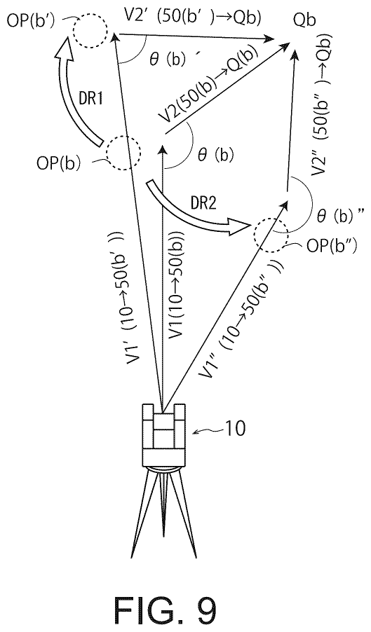

The above content will be described in detail with reference to FIGS. 8 and 9. FIGS. 8 and 9 illustrate a guiding direction of the operator OP. FIG. 8 corresponds to FIG. 6. FIG. 9 corresponds to FIG. 7. In FIG. 8, the measuring module 50 is omitted. Assuming that the angle θ(b) for measuring the farthest position at the position (b) in FIG. 7 is a threshold angle, description will be made based on a state in which the irradiated point Qb is irradiated at the position (b) in FIG. 7.

As illustrated in FIGS. 8 and 9, when the operator OP measures the irradiated point Qb by using the measuring module 50 at the position (b), the control arithmetic unit 60 calculates the angle θ(b) as the angle θ formed between the first vector V1 and the second vector V2. Since the angle (b) is greater or equal to the threshold angle, the control arithmetic unit 60 causes the notification unit 55 to issue a warning. Further, the control arithmetic unit 60 calculates a direction in which the angle θ decreases, and displays the direction on the display unit 57.

Here, since the operator OP receives the warning when irradiating the irradiated point Qb at the position (b), the operator OP moves in the avoidance direction and then resumes the measurement from the irradiated point Qb. A selectable direction as the direction, in which the operator OP moves from the position (b) with reference to the irradiated point Qb, is a first direction DR1 that is the left direction (clockwise) or a second direction DR2 that is the right direction (counterclockwise).

As illustrated in FIG. 9, when the operator OP irradiates the irradiated point Qb at a position (b′) to which the operator OP has moved (rotated) in the first direction DR1, an angle θ(b′) becomes smaller than the angle θ(b). On the other hand, when the operator OP irradiates the irradiated point Qb at a position (b″) to which the operator OP has moved (rotated) in the second direction DR2, an angle θ(b″) becomes larger than 180°. That is, when the operator OP moves in the second direction DR2 from the position (b), the operator OP enters between the measuring module 50 and the surveying instrument 10 in the middle of the movement, and thus hinders the tracking of the surveying instrument 10. The avoidance direction to be selected needs to be a direction in which the angle θ decreases so that the operator OP does not enter between the surveying instrument 10 and the measuring module 50. The control arithmetic unit 60 calculates the direction in which the angle θ decreases, displays the direction on the display unit 57 as the avoidance direction to guide the operator OP.

When the prism 51 deviates from the tracking, the angle θ is considered to be close to 180° immediately before the deviation. Thus, the surveying instrument 10 quickly locks and tracks the prism 51 again, the control arithmetic unit 60 calculates the position coordinates and the angle θ of the irradiated point Q immediately before. The control arithmetic unit 60 displays a guidance sign on the display unit 57, to guide the operator in a direction in which the angle θ decreases. The operator OP moves to the guided direction to face the surveying instrument 10. The surveying instrument 10 locks the prism 51 and tracks it.

It is preferable that the threshold is considerably smaller than 180° so that the tracking is not interrupted depending on the way the operator OP swings his/her hand gripping the measuring module 50. The issuance of the warning from the notification unit 55 enables the operator OP to change an angle of the body so that the tracking is not interrupted and the tracking deviation to be avoided. Since the measuring module 50 can irradiate a certain irradiated point from various angles and directions, the operator OP can immediately cope by changing an angle of the body or a swing angle of the hand gripping the measuring module 50 to avoid the tracking deviation. Therefore, the measurement can be efficiently performed without deviation in the tracking.

Before starting the measurement, as illustrated in FIG. 5, an irradiation test may be performed in which the operator OP stands still and swings the measuring module 50 to measure a plurality of irradiated points Q, and a relative position between the measuring module 50 and the operator OP who grips the measuring module 50 may be calculated with an intersection of the second vector V2 at each irradiated point Q as a schematic position of the operator OP. In addition, a detailed state (gripping with a right/left hand, height, etc.) in which the operator OP grips the measuring module 50 may be input, a schematic position of the operator OP at the time of measurement may be calculated in detail, and a threshold of the angle θ may be determined.

In addition, in three-dimensional data measurement, a height of, for example, a road surface is often measured. In this case, the first vector V1 and the second vector V2 may be calculated as two-dimensional vectors projected on a horizontal plane.

### 5. Three-dimensional Data Measurement Method

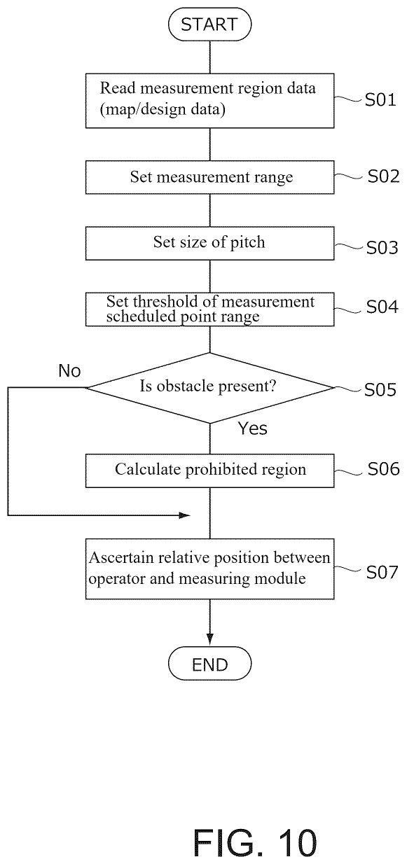

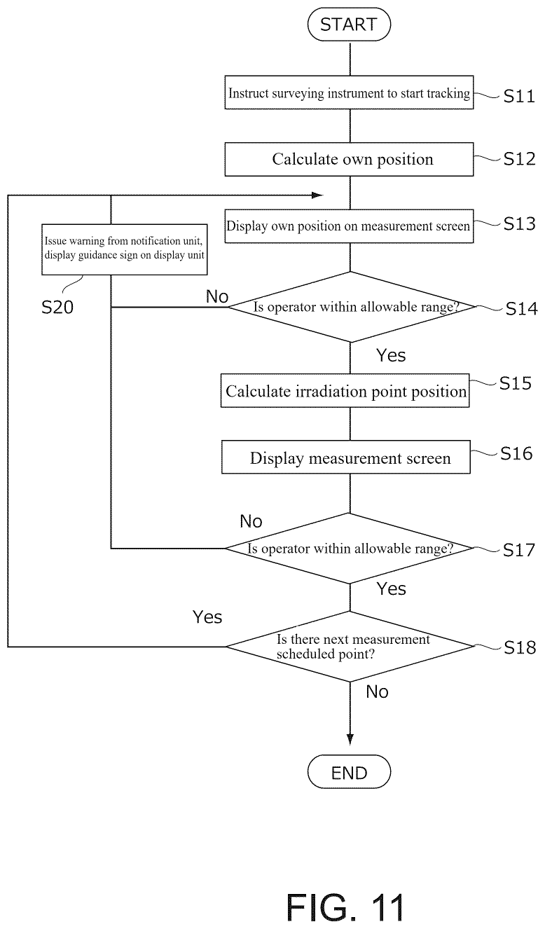

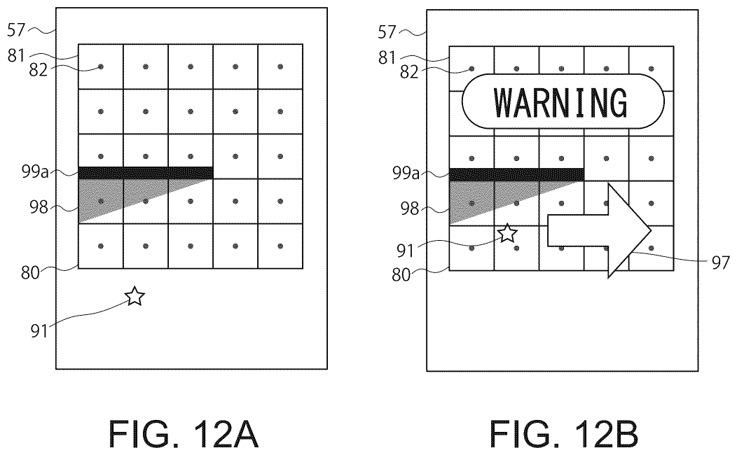

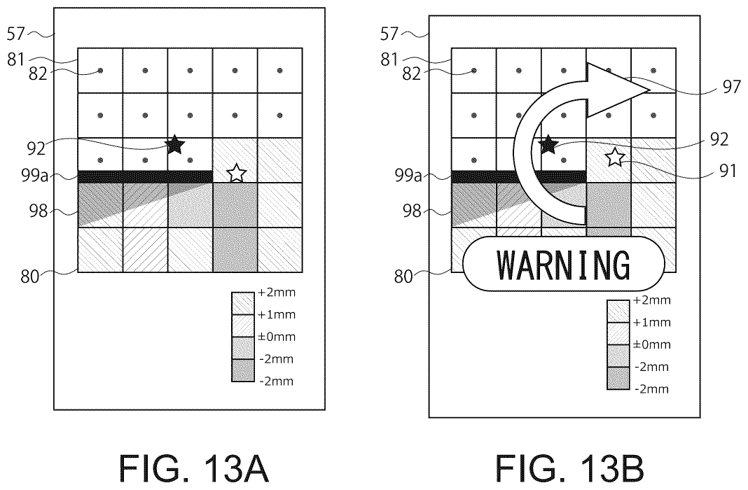

Next, a three-dimensional data measurement method using the system 1 will be described. FIGS. 10 and 11 are flowcharts illustrating an example of a three-dimensional data measurement method using the system 1. FIG. 10 illustrates a pre-process of three-dimensional data measurement. FIG. 11 illustrates a main process thereof. FIGS. 12A to 13B illustrate display screens of the display unit 57 during measurement. Current surface measurement at a construction site will be described as an example.

First, as a preparation for use on site, the surveying instrument 10 is installed at a known point, and the operator OP inputs the coordinates and direction angle of the surveying instrument into the surveying instrument 10.

Second, the operator establishes a connection between the communication unit 58 of the measuring module 50 and the surveying-instrument communication unit 25 of the surveying instrument 10. For combination, for example, the operator OP aligns face to face of the surveying instrument 10 and the measuring module 50, and the prism 51 with the surveying instruments to the direction of the measuring module 50. The operator OP uses the direction information to set the inertial measurement unit 53 with the roll, yaw and pitch angle thereof are zero degree from the opposite direction of the measuring module 50.

### (Flowchart of Pre-Process)

The pre-process of the three-dimensional data measurement method will be described with reference to FIG. 10.

After starting the measurement, in step S01, the control arithmetic unit 60 reads the measurement region data 72. The measurement region data 72 is, particularly, map data or design data of the site that the operator OP is scheduled to measure. The measurement region data 72 may be Computer-Aided Design (CAD) data. The control arithmetic unit 60 may read the measurement region data 72 stored in advance in the storage unit. Alternatively, The control arithmetic unit 60 may read the measurement region data 72 stored in a cloud server or other storages and have stored the measurement region data 72 in advice.

Next, in step S02, the control arithmetic unit 60 sets the measurement range 80 in accordance with the operator's input. For example, the operator can set the measurement range 80 by tapping vertexes on the measurement region data 72 on the display unit 57, which is configured as a touch panel.

Next, in step S03, the control arithmetic unit 60 sets the size of the pitch p, which defines the dimensions of meshes to partition the measurement range 80 into mesh-like partitioned area in accordance with the operator's input through the operation unit 56. The value of the pitch p may be set by using an input method from the operator, for example, selecting a predetermined value, or inputting a value into an input field.

Next, in step S04, the control arithmetic unit 60 sets a threshold of the measurement scheduled point range 83 in accordance with the operator's input. The threshold of the measurement scheduled point range 83 may be set in advance. In this case, step S04 may be omitted.

Next, in step S05, the control arithmetic unit 60 checks the presence or absence of an obstacle from the measurement region data 72. When the obstacle 99 is present (YES), in step S06, the control arithmetic unit 60 calculates a range, in which the prism 51 is likely to be hidden by the obstacle 99, based on a positional relationship with the surveying instrument 10. The control arithmetic unit 60 displays the calculated range on the display unit 57 as the prohibited region 98. For example, FIG. 12A illustrates a case when a standing wall is present in the measurement region (see also the obstacle 99 in FIG. 6), and the control arithmetic unit 60 displays the standing wall on the display unit 57 as obstacle data 99a. The control arithmetic unit 60 also displays the prohibited region 98, in which irradiation with the laser light L1 of the surveying instrument 10 is blocked by the obstacle 99. In this way, the control arithmetic unit 60 displays the prohibited region 98, which is unmeasurable by the surveying instrument 10 even by using the measuring module 50.

Next, in step S07, the control arithmetic unit 60 ascertains the relative position between the operator OP and the measuring module 50 through the above-described test irradiation. Note that step S07 is optional and need not be performed.

### (Flowchart of Main Process)

Next, the main process of the three-dimensional data measurement method will be described with reference to FIG. 11.

In step S11, the control arithmetic unit 60 instructs the surveying instrument 10 to start tracking via the communication unit 58. Then, the surveying instrument 10 tracks the prism 51, measures the prism 51 at predetermined intervals to transmit position coordinates of the prism 51 with the timestamp to the measuring module 50.

Next, in step S12, the control arithmetic unit 60 detects posture information of the measuring module 50 at a timing synchronized with the measurement of the position coordinates of the prism 51 to calculate the position coordinates of the prism 51 to calculate the position coordinates of the instrument center O of the measuring module 50.

Next, in step S13, the control arithmetic unit 60 displays the measurement screen 70 on the display unit 57 to display an own position mark 91 at the position coordinates of the instrument center O of the measuring module 50 on the measurement screen 70 (see FIG. 12A).

Next, in step S14, the control arithmetic unit 60 determines whether the operator OP is within an allowable range. Specifically, the control arithmetic unit 60 calculates a distance between the position coordinates of the instrument center O and the prohibited region 98, to determine whether or not a predetermined distance from the prohibited region 98 is equal to or less than a threshold. The hatched region is the prohibited region 98 in FIG. 12A. When the calculated distance, which is between the position coordinates of the instrument center O and the prohibited region 98, is equal to or less than the threshold, the control arithmetic unit 60 determines that the operator OP is out of the allowable range (NO) so that the operator OP is too close to the prohibited region 98. The notification unit 55 is caused to issue a warning in step S19. Further, the control arithmetic unit 60 displays the guidance sign 97 on the display unit 57 such that the operator moves away from prohibited region 98 (see FIG. 12B). The process returns to step S13.

Thereafter, the control arithmetic unit 60 repeats steps S11 to S14. The control arithmetic unit 60 calculates position coordinates of the instrument center O of the measuring module 50 when receiving the position coordinates of the prism 51 or at a predetermined timing. Upon calculating the position coordinates of the prism 51, the control arithmetic unit 60 updates the measurement screen 70 including an own position mark 91 (FIG. 12B) on the measurement screen 70. The control arithmetic unit 60 calculates the distance between the position of the instrument center O and the prohibited region 98 every time, to guide the operator OP not to approach the prohibited region 98.

In step S15, when the electronic distance meter 52 emits the distance-measuring light L3 to detect a distance to the irradiated point Q, by an instruction from the operator OP or the control by the control arithmetic unit 60, the control arithmetic unit 60 calculates and stores the position coordinates of the irradiated point Q by using posture information of the measuring module 50.

In step S16, the control arithmetic unit 60 displays the position of the irradiated point, which is shown with an irradiated point mark 92 in FIG. 13A, on the measurement screen 70 of the display unit 57. The control arithmetic unit 60 calculates a height value based on the calculated position coordinates of the irradiated point Q and displays measured mesh 81 in colors that very depending on the height value.

In step 17, the control arithmetic unit 60 calculates the first vector V1, the second vector V2, and the angle θ formed between the two vectors from the position coordinates of the surveying instrument 10, the measuring module 50, and the irradiated point Q. When the angle θ is equal to or more than a threshold, The control arithmetic unit 60 determines that the surveying instrument 10 may fail continuous measurement due to the operator OP, and the operator OP is out of the allowable range (NO). The notification unit 55 is cased to issue a warning in step S19. Further, the control arithmetic unit 60 displays the guidance sign 97 on the display unit 57. The process returns to step S13.

Then, the control arithmetic unit 60 always repeats steps S13 to S18 until receiving instruction to end the process in step S18.

As illustrated in FIGS. 12B and 13B, when the operator OP arrives at a position where the operator OP becomes an obstacle that hinders the tracking, the control arithmetic unit 60 displays the guidance sign 97. The guidance sign 97 indicates directions in which the operator OP is to rotate or move. The control arithmetic unit 60 may display the blinking guidance sign 97 largely superimposed at the center of the screen so that the operator OP can intuitively ascertain an avoidance direction. When the warning display is bothered, the operator may turn off the warning display. When the notification unit 55 warns the operator OP, the operator OP only needs to move according to the guidance sign 97. This configurations burden on the operator OP.

### 5. Technical Effects

As described above, in the present embodiment, the measuring module 50 which includes the prism 51, the electronic distance meter 52, and the inertial measurement unit 53, and can acquire the position coordinates of the prism 51. This allows acquiring the irradiated point coordinates of the distance measurement light with the measuring module 50 even if the operator moves. In this way, the operator can perform measurement without using a pole for a prism. Furthermore, the system 1 measures the measuring module 50 with the surveying instrument 10, not with a GNSS device. This ensures that the measurement accuracy indoors is comparable to the outdoors. In addition, this structure eliminates the need to consider the number of the geometric of the satellites.

Further, the measuring module 50 partitions the measurement range into a mesh shape having the predetermined pitch p on the data of the measurement region 7 (measurement region data 72). An operator OP grips and moves the measuring module 50 to scan the measurement range with the distance-measuring light. The measuring module 50 automatically executes measurement when the irradiated point of the distance-measuring light enters the measurement scheduled point range 83. According to this configuration, the measuring module 50 eliminates the need for an operator to stand still and stop the pole for each measurement point, and can thus reduce a work load and shorten a work time.

Moreover, the measuring module 50 includes the display unit 57. The display unit 57 displays the measurement screen 70, which displays in a way to distinguish the measured region and the unmeasured region. This allows the operator to perform the measurement while confirming on work progress. Furthermore, displaying the measured area in colors that vary depending on the height value allows the operator OP to grasp the three-dimensional shape of the measurement range in the real-time manner.

Note that the description has been made assuming that the data of the measurement region 7, which means measurement region data 72, is map data and the measurement range is the ground. However, as described above, the measurement region data 72 may be design data, and the measurement range is not limited to the ground, and may be, for example, a wall surface, a surface of a structure, or a ceiling surface other than the ground. The measuring module 50 has dimensions that allow the measuring module 50 to be small enough to be portable and can thus measure various measurement ranges. According to this configuration, the system 1 can be used for measuring three-dimensional data of various measurement objects depending on the purpose.

In addition, since the measuring module 50 uses visible light for the distance-measuring light L3. This configuration allows the operator OP to move the measuring module 50 while observing the irradiated point Q of the distance-measuring light L3 on the actual object, thereby improving work efficiency.

Since the system 1 performs measurement via the measuring module 50, the measurement can be performed without moving the surveying instrument 10 even when the obstacle 99 is present in the measurement region 7. Even if no data of the obstacle 99 exists in advance as the measurement region data 72 and the obstacle 99 is found at a surveying site, the control arithmetic unit 60 can ascertain the obstacle 99 through irradiation with the distance-measuring light L3 and can calculate the unmeasurable prohibited region 98. Calculation of the prohibited region 98 enables to ascertain in advance that the operator OP approaches the prohibited region 98 and avoid the prohibited region 98.

In the three-dimensional data measurement using the auto-tracking to the prism, deviation in the tracking requires the time to lock the prism again. When the operator OP unintentionally approaches a position where the tracking is interrupted, the notification unit 55 warns the operator OP by using notification means, for example, sound, vibration, or light. Further, the guidance sign 97 notifying the operator OP of an advancing direction is displayed on the measurement screen 70. As described above, even when auto-tracking is used, the system 1 detects a situation in which tracking is likely to deviate and issues a warning, and thus, it is possible to perform efficient measurement by avoiding tracking interruption and shortening the entire time required for measurement. Although the prohibited region is displayed on the screen of the display unit 57 during the work, the operator OP does not need to be constantly aware of the displayed prohibited region and does not need to perform the measurement while being aware of a standing position and an advancing direction of the operator OP. The operator OP may simply avoid the prohibited region when receiving a warning and continue the measurement.

Although the preferred embodiments of the present disclosure have been described above, the above-described embodiments are examples of the present disclosure. These embodiments can be combined based on knowledge of those skilled in the art, and such forms are also included in the scope of the present disclosure.

### REFERENCE SIGNS LIST

1: Three-dimensional data measuring system
5: Housing
5a: Grip portion
10: Surveying instrument
16: Tracking unit
50: Measuring module
51: Prism
52: Electronic distance meter
53: Inertia measurement unit
55: Notification unit
57: Display unit
58: Communication unit
60: Control arithmetic unit
80: Measurement range
97: Guidance sign
98: Prohibited region
99: Obstacle (including operator OP)
L3: Distance-measuring light
O: Instrument center
OP: Operator
Q: Irradiated point
S11˜19: Step
V1: First vector
V2: Second vector
θ: Angle

1. A three-dimensional data measuring system that acquires three-dimensional data of a measurement range, the system comprising:
a measuring module including
a housing having a grip portion,
a prism, attached to the housing, configured to retroreflect incident light,
a notification unit configured to issue a warning,
an electronic distance meter, accommodated in the housing, configured to transmit distance-measuring light to the measurement range, receive reflected distance-measuring light of the distance-measuring light reflected from an irradiated point, and detect a distance to the irradiated point,
an inertial measurement unit configured to detect posture information,
a communication unit configured to receive position coordinates of the prism, and
a control arithmetic unit configured to calculate position coordinates of an own position on the basis of the position coordinates of the prism and the posture information, and calculate position coordinates of the irradiated point on the basis of the position coordinates of the own position, a distance to the irradiated point, and the posture information; and
a surveying instrument configured to measure a distance to and angle of the prism to acquire the position coordinates of the prism, and transmit the position coordinates to the communication unit, wherein
the control arithmetic unit is configured to calculate an angle formed between a vector directed from the surveying instrument to the measuring module and a vector directed from the measuring module to the irradiated point, and cause the notification unit to issue a warning when the angle exceeds a threshold.

2. The three-dimensional data measuring system according to claim 1, wherein
the housing further includes a display unit, and
the control arithmetic unit displays, on the display unit, a guidance sign for guiding an operator holding the measuring module to move in a direction of decreasing the angle when the angle exceeds the threshold.

3. A three-dimensional data measurement method using a three-dimensional data measuring system that acquires three-dimensional data of a measurement range and includes
a measuring module including
a housing having a grip portion,
a prism, attached to the housing, configured to retroreflect incident light,
a notification unit configured to issue a warning,
an electronic distance meter, accommodated in the housing, configured to transmit distance-measuring light to the measurement range, receive reflected distance-measuring light of the distance-measuring light reflected from an irradiated point, and detect a distance to the irradiated point,
inertial measurement unit configured to detect posture information,
a communication unit configured to receive position coordinates of the prism, and
a control arithmetic unit configured to calculate position coordinates of an own position on the basis of the position coordinates of the prism and the posture information, and calculate position coordinates of the irradiated point on the basis of the position coordinates of the own position, a distance to the irradiated point, and the posture information, and
a surveying instrument configured to measure a distance to and angle of the prism to acquire the position coordinates of the prism, and transmit the position coordinates to the communication unit, the method comprising:
calculating, by the control arithmetic unit, an angle formed between a vector directed from the surveying instrument to the measuring module and a vector directed from the measuring module to the irradiated point; and
issuing, by the notification unit, a warning when the angle exceeds a threshold.
